(19) United States
(12) Patent Application Publication
(10) Pub. No.: US 2026/0276238 A1
(43) Pub. Date: Sep. 17, 2026

(54) VENTILATION SYSTEM

(71) Applicant: LG ELECTRONICS INC., Seoul (KR)

(72) Inventors: Donghyun PARK, Seoul (KR); Jlyeon CHOI, Seoul (KR); Kyungjung LEE, Seoul (KR); Sangrak KIM, Seoul (KR); Sooyeon SHIN, Seoul (KR)

(21) Appl. No.: 19/426,271

(22) Filed: Dec. 19, 2025

(30) Foreign Application Priority Data
Mar. 10, 2025 (KR) 10-2025-0030832

(51) Int. Cl. F24F 13/20; F24F 3/147

(52) U.S. Cl. CPC F24F 13/20; F24F 3/147

(57) ABSTRACT

The present disclosure relates to a heat recovery ventilation system. A ventilation system according to an embodiment of the present disclosure comprises a case into which outdoor air and room air flow, a total heat exchanger disposed inside the case to exchange heat between outdoor air and room air, a door having a rotation axis disposed inside the case to open or close a lower side of the case so that the total heat exchanger is separable downward from the case.

### CROSS-REFERENCE TO RELATED APPLICATION

The present application claims priority to Korean Patent Application No. 10-2025-0030832, filed March 10, 2025, the entire contents of which are incorporated herein for all purposes by this reference.

### Technical Field

The present disclosure relates to a ventilation system, and more particularly, to a heat recovery ventilation system.

### Description of Related Art

A ventilation system is a device that exhausts polluted room air to the outdoor side and supplies fresh outdoor air to the indoor side, thereby maintaining the freshness of room air at a certain level.

Heat recovery ventilation systems, which reduce energy loss by recovering waste heat, are commonly used in general homes, and these heat recovery ventilation systems are provided with a total heat exchanger to exchange heat between polluted room air and fresh outdoor air in order to recover waste heat.

For the maintenance of such ventilation system, the total heat exchanger, filter or the like is removed after the lower door is opened. Since the ventilation system is installed on the ceiling of a multipurpose room, a laundry room, or an outdoor unit room, there may be a washing machine, a dryer, a refrigerator, an outdoor unit, or other various items under it. In considering the above carefully, it is required that the door can be opened easily and safely.

### Prior art documents

### Patent Documents

Patent Document 1 KR 10-1250062 B1 on 27 Mar. 2013.

Patent Document 2 KR 10-1190496 B1 on 5 Oct. 2012.

Patent Document 3 KR 10-2009-0078184 A on 17 Jul. 2009.

### Disclosure of the invention

### Problems to be solved

The problem that the present disclosure seeks to solve is to provide a ventilation system whose door can be opened easily and safely.

The present disclosure may have other purposes besides the aforementioned one, which are clearly recognizable to a person skilled in the art from the description below.

### Means of solving the problems

In order to achieve the object, a ventilation system according to an embodiment of the present disclosure comprises a case into which outdoor air and room air flow, a total heat exchanger disposed inside the case to exchange heat between outdoor air and room air, a door having a rotation axis disposed inside the case to open or close a lower side of the case so that the total heat exchanger is separable downward from the case.

In order to achieve the object, a ventilation system according to an embodiment of the present disclosure comprises a case into which outdoor air and room air flow, a total heat exchanger disposed inside the case to exchange heat between outdoor air and room air, a door to open or close a lower side of the case so that the total heat exchanger is separable downward from the case, and having an adjustable opening speed.

Specific details of other embodiments are included in the detailed description and drawings.

### Advantageous Effects

According to the ventilation system of the present disclosure, one or more of the following effects are achieved.

First, it has the advantage of minimizing the space required for the door to be opened because the door's rotation center is inside the case.

Second, it has the advantage that the door is opened safely because the rotation speed of the door is controlled by the damper.

Third, it has the advantage that the button to open the door is convenient to operate, while also reliably locking the door.

The present disclosure can provide other effects besides the ones described above, which are clearly recognizable to a person skilled in the art from the claims.

### DESCRIPTION OF DRAWINGS

FIG. 1 is a perspective view of a ventilation system according to an embodiment of the present disclosure.

FIG. 2 is an exploded perspective view of a ventilation system according to an embodiment of the present disclosure.

FIG. 3 is a drawing illustrating the removal of components of a ventilation system with the doors being opened, according to an embodiment of the present disclosure.

FIG. 4 is an internal structural diagram of a ventilation system according to an embodiment of the present disclosure.

FIG. 5 is a partially exploded perspective view of a ventilation system according to an embodiment of the present disclosure.

FIG. 6 is an exploded perspective view of a door of a ventilation system according to an embodiment of the present disclosure.

FIG. 7 is a partial cross-sectional view of a ventilation system whit the door being closed, according to an embodiment of the present disclosure.

FIG. 8 is a partial cross-sectional view of a ventilation system with the door being opened, according to an embodiment of the present disclosure.

### DETAILED DESCRIPTIONS

Advantages and features of the present disclosure, and a method of achieving the advantages and features will become apparent when referring to the following embodiments described later in detail together with the accompanying drawings. However, the present disclosure is not limited to the embodiments as disclosed below, but may be embodied in various different forms. Thus, these embodiments are set forth only to make the present disclosure complete, and to completely inform the scope of the present disclosure to those of ordinary skill in the technical field to which the present disclosure belongs. Throughout the detailed description, like reference numerals refer to like components.

Although the terms "first", "second", and so on are used to describe various components, these components are not limited by these terms. These terms are merely used to distinguish one component from another component, and unless specifically stated to the contrary, it should be understood that a first component may also be a second component.

Throughout the specification, unless specifically stated to the contrary, each element may be singular or plural.

Hereinafter, the phrase “any configuration is disposed in the upper side of (or in the lower side of) a component" or “on (or below) a component" may mean not only that any configuration is disposed in contact with the upper surface (or lower surface) of said component, but also that another configuration may be interposed between said component and any configuration disposed on (or below) said component.

Additionally, when a component is described as being "connected," "coupled," or "contacted" to another component, it should be understood that although the both components may be directly connected, coupled or contacted to each other, a third component may also be "interposed" between the both components, or the both components may be "connected," "coupled," or "contacted" to each other through a third component.

As used herein, singular expressions include plural expressions unless the context clearly dictates otherwise. Herein, the terms “be comprised of” or “comprise” should not be construed to necessarily include all of the various components or various steps described in the specification, and should be construed to mean that some of the components or some of the steps may not be included, or that additional components or steps may be included.

Throughout the disclosure, the phrase “A and/or B” means A, B, or A and B, unless otherwise specified, and the phrase “C to D” means equal to or greater than C and equal to or smaller than D unless otherwise specified.

Hereinafter, the present disclosure will be described with reference to drawings for explaining a ventilation system according to embodiments of the present disclosure.

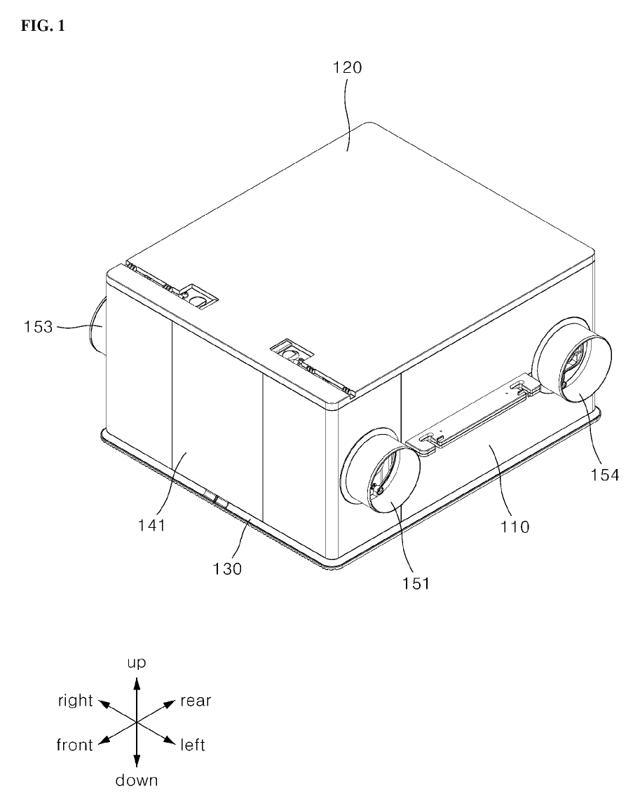

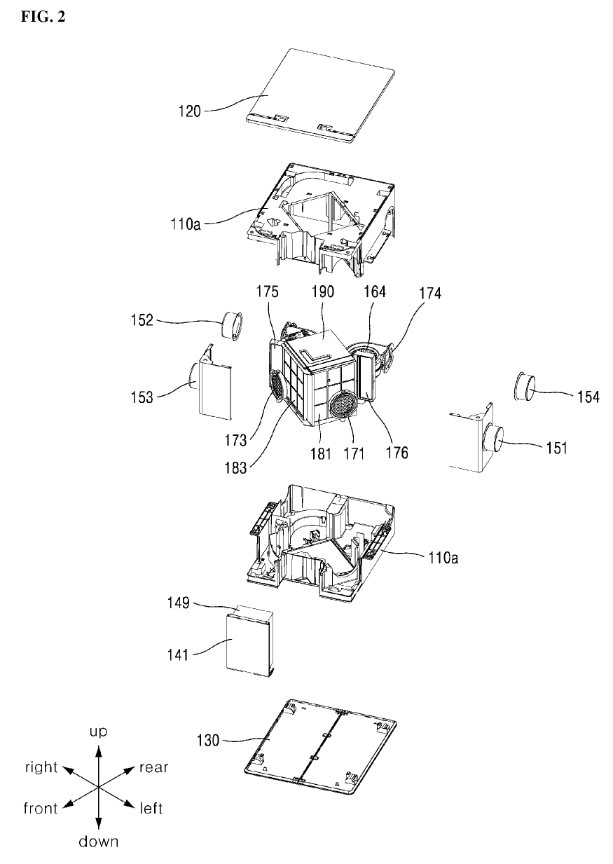

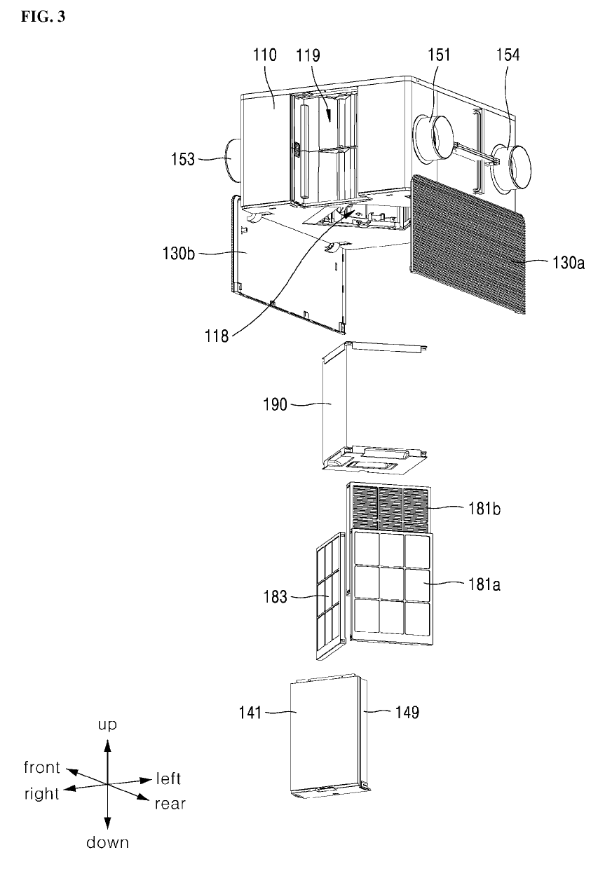

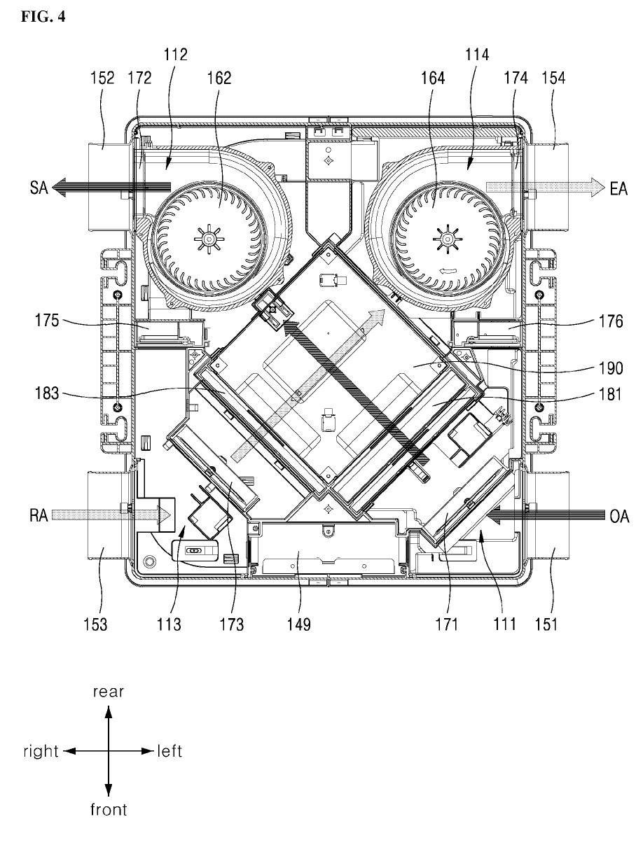

FIG. 1 is a perspective view of a ventilation system according to an embodiment of the present disclosure, FIG. 2 is an exploded perspective view of a ventilation system according to an embodiment of the present disclosure, FIG. 3 is a drawing illustrating the removal of components of a ventilation system according to an embodiment of the present disclosure, and FIG. 4 is an internal structural diagram of a ventilation system according to an embodiment of the present disclosure.

A ventilation system according to an embodiment of the present disclosure comprises a case 110 forming the exterior and into which outdoor air and room air flow, a door 130 rotatably coupled to the lower side of the case 110, a case cover 120 covering the upper surface of the case 110, an exhaust air fan 164 disposed inside the case 110 to discharge air to the outside, a supply air fan 162 disposed inside the case 110 to discharge air to the indoor side, a total heat exchanger 190 disposed in the internal center of the case 110 to exchange heat between outdoor air and room air, a control box 149 disposed inside the case 110 to control the exhaust air fan 164 and the supply air fan 162, and a control box cover 141 coupled to the case 110 to cover the control box 149.

The case 110 has a roughly rectangular parallelpiped shape, and forms the exterior of the ventilation system. The case 110 has a space formed therein in which air flow paths and various parts are installed. The case 110 comprises an upper case 110a forming the upper portion and a lower case 110b forming the lower portion.

The case 110 has four flow paths formed therein through which air flows. Referring to FIG. 4, the case 110 has the following flow paths formed therein: an outdoor air flow path 111 through which air introduced from the outdoor side (outdoor air) flows; an exhaust air flow path 114 through which air to be discharged to the outdoor side flows; a ventilation flow path 113 through which air introduced from the indoor side (room air) flows; and a supply air flow path 112 through which air to be discharged to the indoor side flows.

The case 110 has a central receiving space 118 formed therein in which a total heat exchanger 190, an outdoor air filter 181, and a ventilation filter 183 are received. The central receiving space 118 is disposed to be surrounded by the outdoor air flow path 111, the exhaust air flow path 114, the ventilation flow path 113, and the supply air flow path 112. Referring to FIG. 3, the lower side of the central receiving space 118 is open, so that the total heat exchanger 190, the outdoor air filter 181, and the ventilation filter 183 can be separated downward upon opening of the door 130.

The case 110 has an outer receiving space 119 recessed into the outer side so as to receive a control box 149. The outer receiving space 119 is disposed between the outdoor air flow path 111 and the ventilation flow path 113. Referring to FIG. 3, the lower side of the outer receiving space 119 is open, so that the control box 149 and the control box cover 141 can be separated downward upon opening of the door 130.

In the case 110, an exhaust air fan 164, a supply air fan 162, an outdoor air damper 171, a ventilation damper 173, a bypass damper 175, a circulation damper 176, an exhaust air damper 174, and a supply air damper 172. On the outer sides of the case 110, an outdoor air flange 151, a ventilation flange 153, an exhaust air flange 154, a supply air flange 152, and a control box cover 141 are disposed. On the upper side of the case 110, a case cover 120 is disposed, and on the lower side thereof, the door 130 is disposed.

The case cover 120 covers the upper surface of the case 110, and forms the exterior upper surface. The case cover 120 has a rectangular plate shape, and is coupled to the upper side of the case 110. Between the case cover 120 and the case 110 an insulating material may be provided.

The door 130 opens or closes the lower side of the case 110. The door 130 completely covers the lower surface of the case 110 when closed, or completely expose the lower surface of the case 110 when opened. The door 130 opens or closes the open lower side of the central receiving space 118, so that when opened, the total heat exchanger 190, the outdoor air filter 181, and the ventilation filter 183 can be separated downward. The door 130 opens or closes the open lower side of the outer receiving space 119, so that when opened, the control box 149 and the control box cover 141 can be separated downward.

The door 130 may be provided in plural, and, in the present embodiment, comprises a left door 130a disposed in the side of the outdoor air flange 151 and the exhaust air flange 154, and a right door 130b disposed in the side of the ventilation flange 153 and the supply air flange 152.

The exhaust air fan 164 is disposed in the exhaust air flow path 114 on the left rear in the case 110. The exhaust air fan 164 discharges room air, which is introduced through the ventilation flange 153 and then heat-exchanged in the total heat exchanger 190, to the outdoor side. The exhaust air damper 174 is disposed at the discharge port of the exhaust air fan 164. The discharge port of the exhaust air fan 164 is connected with the exhaust air flange 154. The circulation damper 176 is provided in front of the exhaust air fan 164, and the supply air fan 162 is disposed on the right side of the exhaust air fan 164.

The supply air fan 162 is disposed in the supply air flow path 112 on the right rear in the case 110. The exhaust air fan 162 discharges outdoor air, which is introduced through the outdoor air flange 151 and then heat-exchanged in the total heat exchanger 190, to the indoor side. The supply air damper 172 is disposed at the discharge port of the supply air fan 162. The discharge port of the supply air fan 162 is connected with the supply air flange 152. The bypass damper 175 is provided in front of the supply air fan 162, and the exhaust air fan 164 is disposed on the left side of the supply air fan 162.

The total heat exchanger 190 is disposed in the central receiving space 118 in the center of the case 110. The total heat exchanger 190 is disposed to be surrounded by the outdoor air flow path 111, the exhaust air flow path 114, the ventilation flow path 113, and the supply air flow path 112. The outdoor air filter 181 is disposed on the front left side of the total heat exchanger 190; the ventilation filter 183 is disposed on the front right side thereof; the exhaust air fan 164 is disposed on the rear left side thereof; and the supply air fan 162 is disposed on the rear right side thereof. The total heat exchanger 190 may be removed downward from the case 110 upon opening of the door 130.

The total heat exchanger 190 exchanges heat between outdoor air flowing from the outdoor air flow path 111 to the supply air flow path 112 and room air flowing from the ventilation air flow path 113 to the exhaust air flow path 114. The total heat exchanger 190 comprises a plurality of liners and a plurality of spacers forming a plurality of intersecting flow paths so that outdoor air and room air can flow crossing each other.

The control box 149 is disposed in the outer receiving space 119 at the front center in the case 110. The control box 149 is disposed between the outdoor air flow path 111 and the ventilation flow path 113. The control box 149 is disposed between the outdoor air flange 151 and the ventilation flange 153. The outdoor air flange 151 is disposed in the left side of the control box 149, the ventilation flange 153 is disposed in the right side thereof, and the control box cover 141 is disposed in the front side thereof. The control box 149 is coupled to the case 110, and can be separated downward from the case 110 upon opening of the door 130.

In the control box 149, there are provided electronic components such as a printed circuit board, an integrated circuit, and the like. The control box 149 controls the outdoor air damper 171, the ventilation damper 173, the bypass damper 175, the circulation damper 176, the exhaust air damper 174, the supply air damper 172, the exhaust air fan 164, and the supply air fan 162, while supplying power to them.

The control box cover 141 is disposed in the front center of the case 110. The control box cover 141 is an L-shaped panel covering the front surface and the lower surface of the control box 149. The control box cover 141 shields the outer receiving space 119. The control box cover 141 covers the control box 149 to protect the control box 149. The control box cover 141 forms the exterior side surface together with the side surface of the case 110. The control box cover 141 is detachably coupled to the side surface of the case 110. The control box cover 141 can be separated downward from the case 110 upon opening of the door 130.

A ventilation system according to an embodiment of the present disclosure further comprises the outdoor air damper 171 disposed in the outdoor air flow path 111 to allow or stop the inflow of outdoor air, the ventilation damper 173 disposed in the ventilation flow path 113 to allow or stop the inflow of room air, the exhaust air damper 174 disposed in the exhaust air fan 164 to allow or stop the discharge of air, the supply air damper 172 disposed in the supply air fan 162 to allow or stop the discharge of air, the bypass damper 175 guiding room air in the ventilation flow path 113 to the exhaust path 114 when opened, the circulation damper 176 guiding room air in the exhaust path 114 to the outdoor air flow path 111 when opened, the outdoor air flange 151 connected with an outdoor air duct extending outdoors to allow outdoor air to be introduced thereinto, the ventilation flange 153 connected with a ventilation duct extending indoors to allow room air to be introduced thereinto, the exhaust air flange 154 connected with an exhaust air duct extending outdoors to allow air to be discharged to the outdoor side, the supply air flange 152 connected with a supply air duct extending indoors to allow air to be discharged to the indoor side, the outdoor air filter 181 purifying air introduced through the outdoor air flow path 111, and the ventilation filter 183 purifying air introduced into the ventilation flow path 113.

The outdoor air damper 171 is disposed in the outdoor air flow path 111 on the front left in the case 110. The outdoor air damper 171 is disposed between the outdoor air flange 151 and the total heat exchanger 190 to allow or stop the flow of air introduced from the outdoor side or to adjust the air volume thereof.

The ventilation damper 173 is disposed in the ventilation flow path 113 on the front right in the case 110. The ventilation damper 173 is disposed between the ventilation flange 153 and the total heat exchanger 190 to allow or stop the flow of air introduced from the indoor side or to adjust the air volume thereof.

The exhaust air damper 174 is disposed in the exhaust air flow path 114 on the rear left in the case 110. The exhaust air damper 174 is disposed at the discharge port of the exhaust air fan 164 to allow or stop the flow of air discharged from the exhaust air fan 164 to the outdoor side or to adjust the air volume thereof. The exhaust air damper 174 allows or stops the inflow of air from the outdoor side.

The supply air damper 172 is disposed in the supply air flow path 112 on the rear right in the case 110. The supply air damper 172 is disposed at the discharge port of the supply air fan 162 to allow or stop the flow of air discharged from the supply air fan 162 to the indoor side or to adjust the air volume thereof. The supply air damper 172 allows or stops the inflow of air from the indoor side.

The bypass damper 175 is disposed on the center right in the case 110. The bypass damper 175 is disposed between the ventilation flow path 113 and the supply air flow path 112 to guide air from the ventilation flow path 113 to the exhaust path 114 when opened.

The circulation damper 176 is disposed at the left center in the case 110. The circulation damper 176 is disposed between the exhaust path 114 and the outdoor air flow path 111 to guide air from the exhaust path 114 to the outdoor air flow path 111 when opened.

The external flange 151 is disposed on the front left outside of the case 110. The outdoor air flange 151 guides air introduced from the outdoor side to the outdoor air flow path 111. The outer flange 151 protrudes toward the left, but may protrude toward the front depending on an embodiment.

The ventilation flange 153 is disposed on the front right outside of the case 110. The ventilation flange 153 guides air introduced from the indoor side to the ventilation flow path 113. The ventilation flange 153 protrudes toward the right, but may protrude toward the front depending on an embodiment.

The exhaust air flange 154 is disposed on the rear left outside of the case 110. The exhaust air flange 154 guides air discharged from the exhaust air fan 164 to the outdoor side.

The supply air flange 152 is disposed on the rear right outside of the case 110. The supply air flange 152 guides air discharged from the supply air fan 162 to the indoor side.

The outdoor air filter 181 is disposed in the outdoor air flow path 111 on the front left in the case 110. The outdoor air filter 181 is disposed between the outdoor air damper 171 and the total heat exchanger 190 to purify air introduced from the outdoor side. The outdoor air filter 181 may be a variety of filters removing odors or harmful substances or filtering out fine substances, and in this embodiment, the outdoor filter 181 comprises an outdoor air dust filter 181a filtering out fine substances and an outdoor air deodorizing filter 181b removing odors, as shown in FIG. 3.

The ventilation filter 183 is disposed in the ventilation flow path 113 on the front right in the case 110. The ventilation filter 183 is disposed between the ventilation damper 173 and the total heat exchanger 190 to purify air introduced from the indoor side. The ventilation filter 183 may be a variety of filters removing odors or harmful substances or filtering out fine substances, and in this embodiment, the ventilation filter 183 is a dust filter filtering out fine substances.

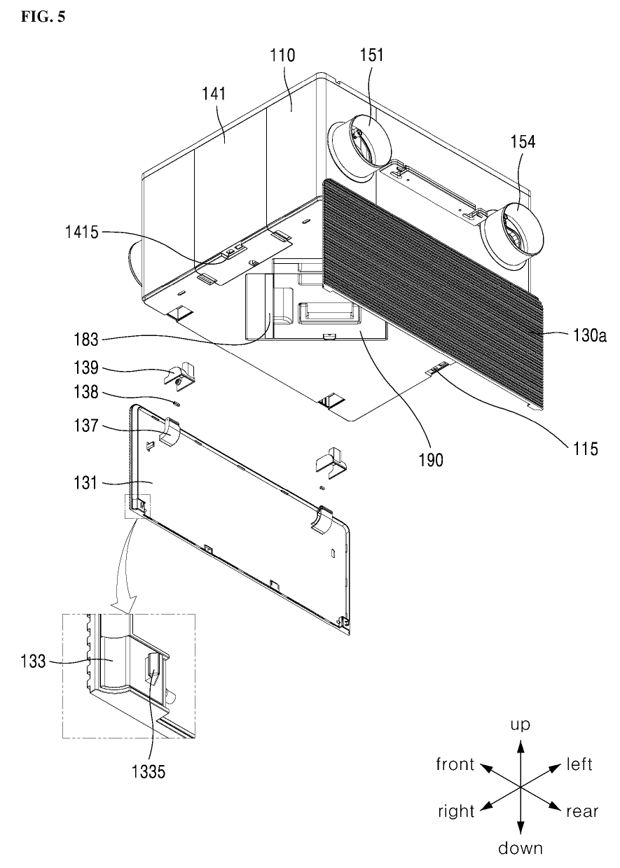

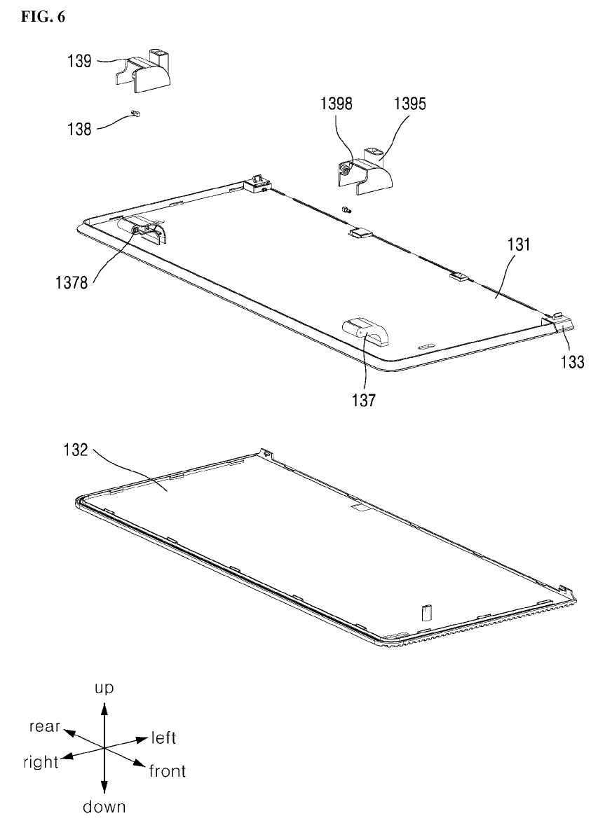

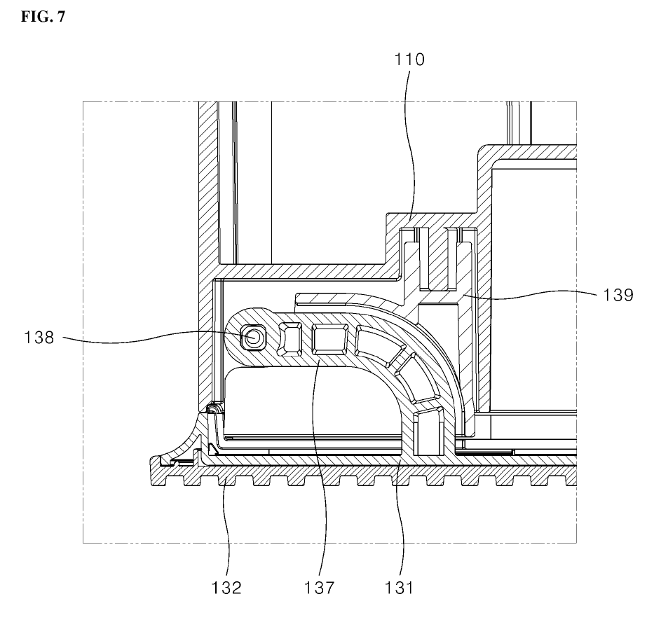

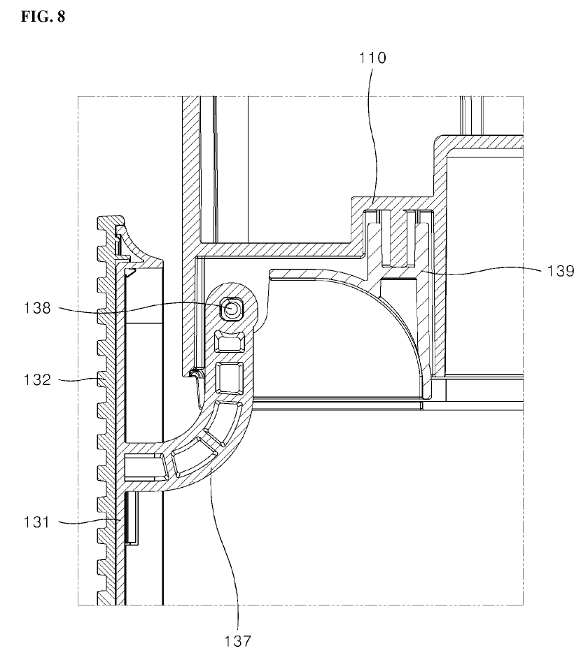

FIG. 5 is a partially exploded perspective view of a ventilation system according to an embodiment of the present disclosure, FIG. 6 is an exploded perspective view of a door of a ventilation system according to an embodiment of the present disclosure, FIG. 7 is a partial cross-sectional view of a ventilation system whit the door being closed, according to an embodiment of the present disclosure, and FIG. 8 is a partial cross-sectional view of a ventilation system with the door being opened, according to an embodiment of the present disclosure.

The door 130 opens or closes the lower side of the case 110 so that the control box 149, the control box cover 141, the total heat exchanger 190, the outdoor air filter 181, or the ventilation filter 183 can be separated downward from the case 110.

The door 130 is rotatably coupled to the case 110 with the rotation axis being disposed inside the case 110. Referring to FIGS. 7 and 8, the rotation axis of the door 130 is farther from the lower surface of the case 110 than from the side surface of the case 110. Thereby, it is possible to minimize the space required to open the door 130. The opening speed of the door 130 is adjusted so that it does not open too quickly.

Referring to FIGS. 5 and 6, the door 130 comprises a door body 131 forming the main body of the door, a door cover 132 covering the outer surface of the door body 131, a door hinge 137 formed to protrude from the door body 131, a hinge housing 139 coupled to the inside of the case 110 and rotatably coupled with the door hinge 137, a door damper 138 coupled to the door hinge 137 and the hinge housing 139 to control the rotation speed, and a door button 133 unlocking the door 130 to be opened when operated (pressed).

The door body 131 is a rectangular flat plate shape with the long side in the direction of the rotation axis of the door 130. The door hinge 137 is disposed beside one long side of the door body 131, and the door button 133 is disposed beside the other long side. The door hinge 137 is disposed on the inner surface of the door body 131 (the surface facing the case 110 when the door 130 is closed), and the door cover 132 is disposed on the outer surface thereof.

The door cover 132 is a part of the ventilation system installed on the ceiling, which is exposed to the outside, protects the ventilation system, and improves its appearance. The door cover 132 completely covers the outer surface and edges of the door 130.

The door hinge 137 has an L-type bracket shape protruding from the inner surface of the door body 131 in a direction perpendicular to the door body 131, then bending at a 90-degree angle to extend in a direction parallel to the door body 131. The door hinge 137 has a circularly bent portion. In the door hinge 137, the length of a portion parallel to the door body 131 is greater than the length of a portion perpendicular to the door body 131. The door hinge 137 is designed so that the rotation axis of the door 130 is disposed as deep as possible inside the case 110, thereby minimizing the space in which the door 130 opens. The door hinge 137 has a hinge damper groove 1378 formed at the free end, into which the door damper 138 is inserted.

On one door 130 a pair of door hinges 137 are provided, and the pair of door hinges 137 are disposed at the front and rear ends of one long side of the door body 131, respectively to be spaced apart from each other as far as possible.

Referring to FIG. 8, the door body 131 does not touch the side surface of the case 110 upon opening of the door 130, but the door hinge 137 touches the side surface of the case 110. That is, the door hinge 137 acts as a stopper upon opening of the door 130, thereby limiting the opening angle of the door 130.

The hinge housing 139 has a roughly hexahedral shape with a space formed therein to accommodate the door hinge 137 and the door damper 138. The hinge housing 139 has a round surface formed to correspond to the circularly bent portion of the door hinge 137. The hinge housing 139 has a hinge housing boss 1395 formed to protrude from the round surface and be coupled to the case 110. The hinge housing 139 has a housing damper groove 1398 formed at one corner spaced apart from the door body 131, into which the door damper 138 is inserted.

A pair of hinge housings 139 are provided for one door 130 so that the pair of hinge housings 139 are disposed corresponding to the pair of door hinges 137.

The door damper 138 is coupled at one end to the hinge damper groove 1378, and coupled at the other end to the housing damper groove 1398 to control the rotational movement of the door hinge 137 and the hinge housing 139. The door damper 138 comprises a fluid or spring mechanism therein to control the opening and closing speeds of the door 130. The door damper 138 prevents the rapid opening movement of the door 130, and provides a cushioning effect to the closing movement of the door 130.

The door button 133 is disposed at a location spaced apart as far as possible from the rotation axis of the door 130 toward the opposite side of the door body 131. The door button 133 is disposed so as to be spaced apart as far as possible from the door hinge 137. Thereby, the door button 133 enables the door 130 to be locked stably with a small latch force. Additionally, the user can unlock the door 130 stably with the operation(pressing) of the door button 133.

Referring to FIG. 5, the door button 133 comprises a door hook 1335 shaped to be latched on the lower surface of the control box cover 141 or the lower surface of the case 110.

A pair of door buttons 133 are provided on one door 130 so that the pair of door buttons 133 are disposed at the front and rear ends of the other long side of the door body 131, respectively so as to be spaced apart as far as possible from each other. The door hook 1335 of the door button 133 disposed at the front end of the door 130 is latched by the door keeper 1415 of the control box cover 141, and the door hook 1335 of the door button 133 disposed at the rear end of the door 130 is latched by the case keeper 115 of the case 110.

While the preferred embodiments of the present disclosure have been illustrated and described above, the present disclosure is not limited to the specific embodiments described above, and, rather, various modifications or changes can be made to the preferred embodiments by those skilled in the art without departing from the scope of the present disclosure as claimed in the claims, and thus these modified embodiments should not be understood as being separate from the technical idea or prospect of the present disclosure.

What is claimed is:

1. A ventilation system comprising:
a case into which outdoor air and room air flow;
a total heat exchanger disposed inside the case to exchange heat between outdoor air and room air; and
a door having a rotation axis disposed inside the case to open or close a lower side of the case so that the total heat exchanger is separable downward from the case.

2. The ventilation system of claim 1, wherein the rotation axis of the door is farther from a lower surface of the case than from a side surface of the case.

3. The ventilation system of claim 1, wherein the door comprises:
a door body;
a door hinge formed to protrude from the door body;
a hinge housing coupled to an inside of the case, and rotatably coupled with the door hinge;
a door damper coupled to the door hinge and the hinge housing to control a rotation speed.

4. The ventilation system of claim 3, wherein the door hinge has an L-type bracket shape.

5. The ventilation system of claim 4, wherein the door hinge has a circularly bent portion, and
wherein the hinge housing has a round surface formed to correspond to the circularly bent portion of the door hinge.

6. The ventilation system of claim 5, wherein the hinge housing has a hinge housing boss formed to protrude from the round surface and be coupled to the case.

7. The ventilation system of claim 4, wherein the door hinge has a portion parallel to the door body whose length is greater than a length of a portion perpendicular to the door body.

8. The ventilation system of claim 3, wherein the door hinge has a hinge damper groove formed at its free end, into which the door damper is inserted.

9. The ventilation system of claim 3, wherein the door hinge touches a side surface of the case upon opening of the door.

10. The ventilation system of claim 3, wherein the door further comprises a door button disposed at a location spaced apart as far as possible from the rotation axis toward an opposite side of the door body.

11. The ventilation system of claim 10, wherein the door button comprises a door hook to be latched on a lower surface of the case.

12. A ventilation system comprising:
a case into which outdoor air and room air flow;
a total heat exchanger disposed inside the case to exchange heat between outdoor air and room air; and
a door to open or close a lower side of the case so that the total heat exchanger is separable downward from the case, and having an adjustable opening speed.
